(19) United States
(12) Patent Application Publication
(10) Pub. No.: US 2007/0255715 A1
(43) Pub. Date: Nov. 1, 2007

(54) Collaborative hub system for accessing and managing shared business content

(75) Inventors: John Yu-Hsien Li, Saratoga, CA (US); Lin Wang, Palo Alto, CA (US)

Correspondence Address: COURTNEY STANIFORD & GREGORY LLP, P.O. BOX 9686, SAN JOSE, CA, 95157, US

(73) Assignee: BayHub, Inc.

(21) Appl. No.: 11/411,319

(22) Filed: Apr. 26, 2006

(51) Int. Cl. G06F 17/30

(52) U.S. Cl. 707/10

(57) ABSTRACT

In one embodiment, an application integration system collects business application information and generates and stores certain business flow and state information for the application, its involved users and shared business content within the system. This automation process defines the collaboration models between the content, process and users involved in the collaboration project. The automation process uses specific information pertaining to the involved users and applications of the system, the process flows of the application program, and the shared content to automate the integration of the distributed computer applications by defining the integration flow as a process checkpoint flow consisting of numerous checkpoints through which the business content transitions. Users of the collaboration hub platform are provided with an interactive console within a graphical user interface presented on their respective computing devices. The displayed graphical user interface elements are generated based on the shared business content and process flows of the distributed applications comprising the integrated project.

### CROSS-REFERENCE TO RELATED APPLICATIONS

The current application is related to U.S. Patent Application entitled “Checkpoint Flow Processing System for On-Demand Integration of Distributed Applications” filed on Apr. 25, 2006, and U.S. Patent Application entitled “Content Driven Process Routing for Integrated Enterprise Applications” filed on Apr. 25, 2006.

### FIELD

Embodiments of the invention relate generally to computer applications, and more specifically, to a collaboration hub and graphical user interface system for managing shared business content.

### BACKGROUND

The traditional deployment of enterprise applications or applications in similar distributed computing environments is characterized by the implementation and use of separate application programs among different users or teams in the overall organization. For example, in a manufacturing organization, one team may use a CAD/CAM program to design and manage the production of a product, while other teams may use finance programs, inventory management programs, customer relationship management (CRM) programs, and so on to manage their respective aspects of the project. Typically, each application is treated as a separate program with its own set of users, input/output data, business rules, timelines, process flows, and so on. Throughout the entire project lifecycle (referred to as the “checkpoint flow”), business content, in the form of documents, files, databases, contacts and the like is continually created and modified by the people and the processes within the system. However, it is usually the case that a common set of data or content is used by the different teams. The deployment of individual “silo applications” generally does not facilitate the sharing of common data and often results in little or no cross work team communications, as each user in each application is assigned a specific and unique role as well as sets of business rules and processes, and has little if any access or interaction with any other application or the business content of those applications. Because business content data and processes are usually managed by each individual application, little or no data synchronization or true sharing is typically possible. Normally the shared cross team business content information is controlled and managed by different groups of users and groups of silo applications. Thus, when a cross team member needs to synchronize the content or project status, he or she must often dump the shared business content to a flat file/spreadsheet from the application and email or fax it to the team members and partners in order to share this content. This manual and mesh-based communication method is error-prone, lacks integrity, virtually unmanageable, time consuming, and potentially very costly in the context of complicated enterprise projects.

The management of content, user communication, process interactions, and application rules is especially problematic in current deployed enterprise systems that involve several different teams all running disparate applications, yet require some degree of interactivity and efficient collaborations. This is largely due to the fact that content is usually stored in flat file structures and each team has its own application platform, deployment infrastructure and defined business processes and user roles. As mentioned above, user interaction in this case often requires individual transmission of business content and manual transmission modes, such as fax/phone/e-mail outside of each user's application platform without management of any overall project level integrity, and is thus an inefficient, insecure, and costly method of communication that results in a lack of synchronization, automation and unmanaged network of communications. Although enterprises can choose to implement the point-to-point integration of applications or users, such integration links typically result in a complicated mesh scheme where every application or user is connected to or integrated with every other application or user. Moreover, the lack of an efficient way to manage distributed project processes, such networks often contain a large number of conflict integration rules and business processes, resulting error-prone business interactions and poor business content integrity.

A further disadvantage of present application management processes is that they do not accommodate collaboration among various teams who may be involved in a variety of different enterprise applications. As stated above, this is due to the fact that content is usually stored in flat file structures and each team has its own application platform, deployment infrastructure, and defined user roles. User interaction thus often still requires individual transmission of business content and manual transmission modes, such as fax/phone/e-mail outside of each user's application platform. Such current systems do not provide an integrated user interface that allows users of different applications to access data and interact with one another through a unified communication and interface system.

### SUMMARY OF THE INVENTION

Embodiments are directed to an application integration and collaboration platform process that facilitates the on-demand integration of business applications implemented on a distributed network platform. The entire business process for the involved applications and users within the system is defined as a project or process checkpoint flow. Each checkpoint represents a content modification or process routing step that involves one or more users and/or applications. The content data is modeled as content objects based on object metadata definitions, and the users or applications that use the content are defined by the rich object field matrix. The checkpoint flow, content data definitions and rich object field matrix definitions are combined to create database structures that store the business content data as multi-dimensional objects. In this manner, the content data and database structures incorporate dynamic rules representing the workflow process and the user and application information. Several components associated with the application integration process, such as versioning, logging, locking and business rule engines facilitate the protection of data integrity, and storage of history information associated with the business content as it is processed by the enterprise applications. This linkage model facilitates automated processes that help integrate different enterprise applications of the project, as well as graphical user interface elements that provide comprehensive control over the process steps and user interaction. The shared business content that is used by the separate enterprise applications and manipulated through multiple checkpoint and interactive processes involving different users and applications at different stages is managed as shared content objects under an integrated application platform. The integration of checkpoint processes, user and application information, and business content definitions also facilitates the creation of collaboration hubs among users who may be involved in different tasks associated with the project, or even in a variety of different enterprise applications that may share some common aspects such as data or users.

The users of the collaboration hub platform are provided with an interactive console within a graphical user interface presented on their respective computing devices. The displayed graphical user interface elements are generated based on the shared business content and process flows of the distributed applications comprising the integrated project. The graphical user elements are automatically generated by the application integration process upon runtime of the system. The checkpoint process flow at any stage of the project can be displayed with varying degrees of granularity, and links are provided to the content and users involved at any step of the process. Present and past versions, as well as various representations of the business content can be displayed by selecting particular stages of the process.

### BRIEF DESCRIPTION OF THE DRAWINGS

Embodiments of the present invention are illustrated by way of example and not limitation in the figures of the accompanying drawings, in which like references indicate similar elements and in which:

FIG. 1A is a block diagram of a computer network system that implements embodiments of a application integration system.

FIG. 1B illustrates the interactivity among a plurality of business applications and entities, according to an embodiment.

FIG. 1C illustrates the storage of business content on a collaboration hub platform, according to an embodiment.

FIG. 2 illustrates the main execution modules of an application integration system, according to an embodiment.

FIG. 3 is a flowchart that illustrates processing steps associated with the business content engine, according to an embodiment.

FIG. 4 illustrates the tagging of business content with identifier hooks, under an embodiment.

FIG. 5 illustrates the concept of transitioning a business content unit through checkpoints, according to an embodiment.

FIG. 6 illustrates the association of process flow with phase and business content, according to an embodiment.

FIG. 7 illustrates an example of the checkpoint flows for an illustrative content object, under an embodiment.

FIG. 8 is a flowchart that illustrates the process flow through the checkpoint flow process, according to an embodiment.

FIG. 9A illustrates the definition of checkpoints and interactive processes, under an embodiment.

FIG. 9B illustrates the derivation of a transition node tree for the checkpoint flows and interactive processes and approval chains of FIG. 9A.

FIG. 9C illustrates the derivation of a node tree for the checkpoint flows and interactive processes of FIG. 9A.

FIG. 10A illustrates an example of a process instance representation of a process definition, under an embodiment.

FIG. 10B illustrates an example of a collaboration log for the process instance illustrated in FIG. 10B.

FIG. 10C illustrates an example of a content instance for the process instance illustrated in FIG. 10B.

FIG. 11 illustrates the generation of user interface components by an interactive console/user interface engine, under an embodiment.

FIG. 12 illustrates an example of a web page for creating or revising shared content within the cross-team project, according to an embodiment.

FIG. 13 illustrates an example of a user interface showing checkpoint flows for a business application, according to an embodiment.

FIG. 14 illustrates an example of an approval subprocess for the checkpoint flow process illustrated in FIG. 13.

### DETAILED DESCRIPTION

Embodiments of a system for providing a collaboration platform that integrates a number of different applications and work teams in a distributed enterprise environment are described. In the following description, numerous specific details are introduced to provide a thorough understanding of, and enabling description for, embodiments of the application integration process. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

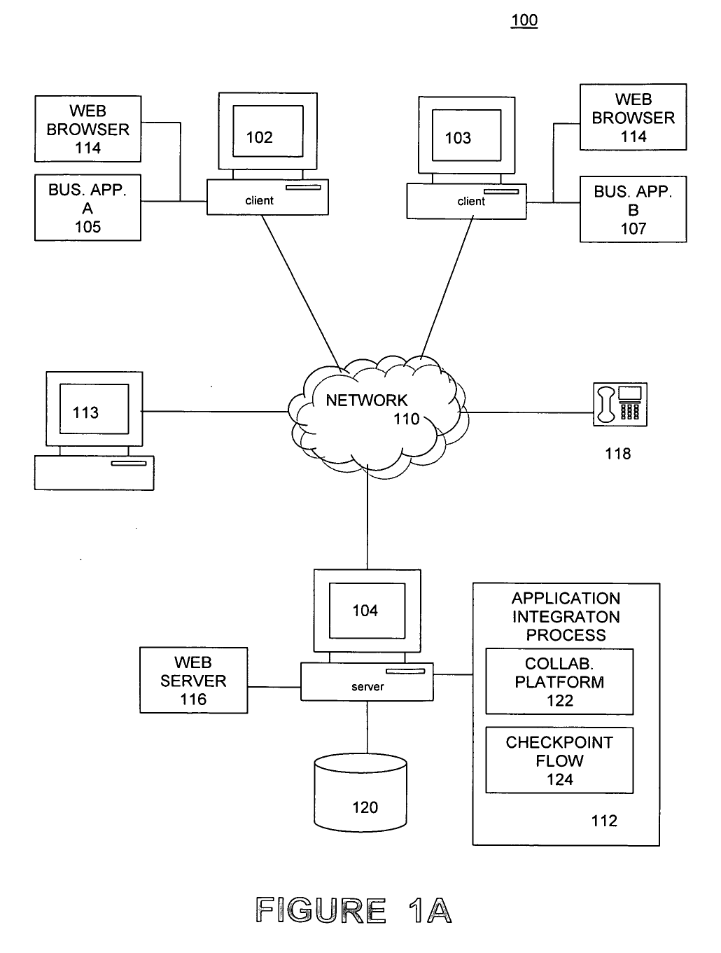

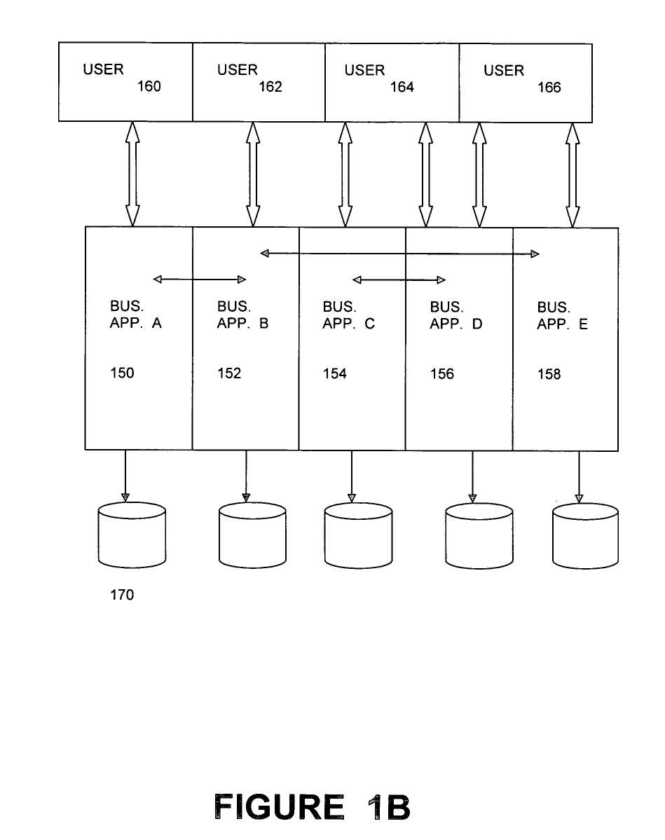

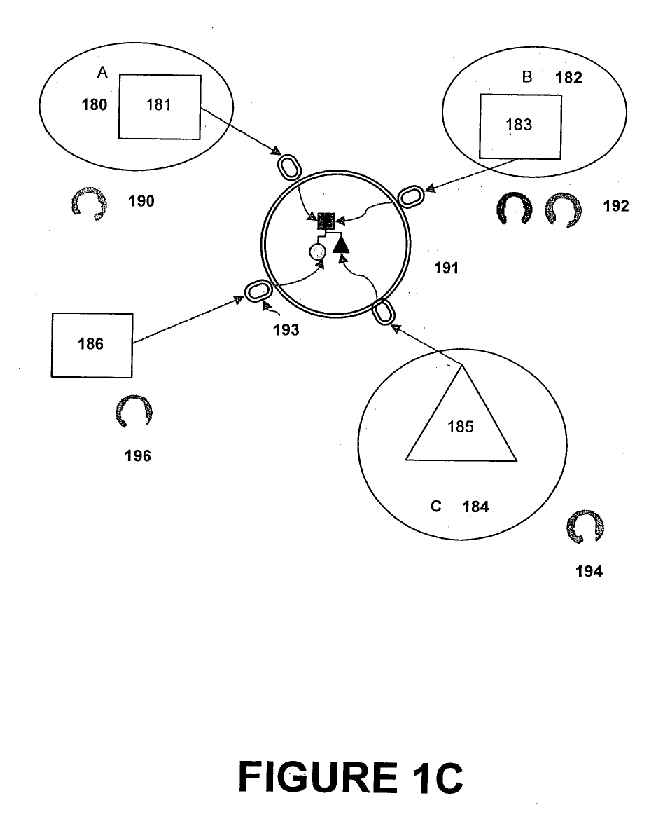

Aspects of the one or more embodiments described herein may be implemented on one or more computers executing software instructions. The computers may be networked in a client-server arrangement or similar distributed computer network. FIG. 1A illustrates a computer network system 100 that implements one or more embodiments. In system 100, a network server computer 104 is coupled, directly or indirectly, to one or more network client computers or computing devices 102, 103 and 118 through a network 110. The network interface between server computer 104 and client computer 102 may include one or more routers that serve to buffer and route the data transmitted between the server and client computers, and network 110 may be the Internet, a Wide Area Network (WAN), a Local Area Network (LAN), or any combination thereof.

In one embodiment, the server computer 104 includes an optional World-Wide Web (WWW) server 116 or server clustering environment that stores data in the form of web pages and transmits these pages as Hypertext Markup Language (HTML) files over the Internet 110 to the client computers. For this embodiment, the client computers typically run a web browser program, such as 114 to access the web pages served by server computer 116 and any available content provider or supplemental server 113.

The network client computers are configured to run a business application program, or to run as or as a dummy client which only has a web browser application available. As shown in FIG. 1A, client 102 runs business application A, 105, and client 103 runs business application B, 107. The business applications can be standalone programs executed locally on the respective client computer, or they can be portions of a distributed client application run on the client or a network of client computers.

Another class of client computers is represented by mobile client 118. Mobile client 118 can be a mobile computing or communication device, such as a notebook computer, personal digital assistant (PDA), mobile phone, game console, or any similar class of mobile computing device with sufficient processing and communication capability. The mobile client 118 generally does not execute server like business applications, but may access the server computers over the network 110. For example, the mobile client may be operated by a user who has temporary access to resources on the server computers through Internet or similar network access.

In one embodiment, server 104 in network system 100 is a server that executes a server side application integration process 112. The application integration process includes functional components that perform the tasks of integrating different application programs used in the project, providing a collaboration hub for the different teams of the project, and automating the business process definitions for the individual business applications. For the embodiment illustrated in FIG. 1 A, the application integration process includes a collaboration platform component 122 and a checkpoint flow component 124. These two components generally use specific information pertaining to the users of the system, the process flows of the overall project (referred to as “checkpoint” flows), and the shared business content used among all involved applications and/or users to automate and combine certain aspects of all of the application programs used in the overall business or project, such as the content management and user collaboration aspects of the application. In general, this is accomplished by defining the overall project workflow as a checkpoint flow consisting of numerous checkpoints through which the business content transitions. Management of the shared business content among different users and applications is controlled through recursive decomposition of each check point of the entire project flow—the derived check point leaf node renders the proper actions/events to the appropriate user or application at the right time.

The programs within the application integration process 112 or integration engine block 212 may represent one or more executable programs modules that are stored within network server 104 and executed locally within the server. Alternatively, process 112 may be stored on a remote storage or processing device coupled to server 104 or network 110 and accessed by server 104 to be locally executed. In a further alternative embodiment, the application integration process 112 may be implemented in a plurality of different program modules, each of which may be executed by two or more distributed server computers coupled to each other, or to network 110 separately.

For an embodiment in which network 110 is the Internet, network server 104 executes an optional web server process 116 to provide HTML objects, typically in the form of web pages, to client computers coupled to the network. To access the HTML files provided by server 104, client computer 102 executes a web browser process 114 that accesses web pages available on server 104 and resources, such as supplemental server 113. The client computers may access the Internet 110 through an Internet Service Provider (ISP). Content for any of the applications contained within or associated with a business application used by the client computer 102 may be provided by a data store 120 closely or loosely coupled to any of the server 104 and/or each client computer. In one embodiment, only the business content data or references to the content that is commonly shared among the applications and end users are stored at content store 120. In addition, each application may have its own database storage at the client side, and some of this data might not be of interest to other applications and users. A separate content provider 113 may provide some of the data that is included in any business application generated, transmitted, or executed over system 100. Although data store 120 is shown coupled to the network server 104, it should be noted that content data may be stored in one or more data stores coupled to any of the computers of the network, such as network client 102 or to devices within the network 110 itself.

In one embodiment, the users of each client computer 102 and 103 execute one or more business applications 105 and 107 that may be used as part of an overall business or project. For purposes of the following discussion the terms “overall business” or “project” refer to an endeavor that involves a number of different users operating a number of different computers that may execute different business application programs, and the terms “business application,” “application program,” and “enterprise application” all refer to an application program 105 or 107 that is executed on the client computer. In general, a business application is a computer program that may itself involve a number of different users, each of whom may be involved in one or more particular aspects of a business process. The business application, also referred to as an “enterprise application” involves the execution of a number of different task or processes involving the users. The business application typically also involves the creation, modification, storage and use of a number of different business content data used by the application. The overall project may involve the use of several different applications operated by different teams who perform different tasks and contribute to separate aspects of the project.

The overall business project implemented by system 100 typically embodies many different users, processes and content objects interacting with one another over a distributed computer network. FIG. 1B illustrates the interactivity among a plurality of business applications and entities, according to an embodiment. As shown in FIG. 1B, a number of different business applications denoted business application A through business application E are operated by one or more users (teams), each performing their own task. Each application corresponds to a business application executed on a client computer, such as client 102 or 103 of FIG. 1A. In one embodiment, the application integration aspect of the application integration process 112, integrates the process flows, business data, user privileges, and even external team relationships so that the individual applications are integrated as part of an entire project, rather than a combination of separate applications. Each application also generates, stores, and maintains its business content in its own respective content store, e.g., data store 170. The interactivity provided by the application integration process 112 allows user teams 160 to 166 from the different applications to communicate with teams from other applications through the business process flows and/or the business content used by their respective application programs. Thus, as shown by the example cross work team communication of FIG. 1B, application A can interact directly with application B, application B can interact with application E, and application C can interact with application D, and so on. Any degree of interactivity among and between the different applications, as well as between the applications and any external entities can vary depending upon the actual requirements and constraints of the overall business project.

The applications illustrated in FIG. 1B can be any type of program that performs a task within the business, such as finance, design, media production, enterprise resource planning, inventory, interactive video streaming, and any other type of program. The application integration process essentially converts the individual silo applications to virtual business applications that are leveraged to provide cross-team features. At run-time, the applications are practically merged to form interacting components of the overall project with collaboration among the different teams and true sharing of the common business content data. In one embodiment, the checkpoint flow of the project defines the points of entry (checkpoints) for the various teams with respect to the business content.

Business content generally refers to any content that is created, modified, or otherwise used by the applications comprising the overall project. It should be noted that the term “content” can refer to any real or virtual collection of business data, objects or information used by the system. Such business content may be organized as files, documents, databases, pages, lists, or similar objects, and could include many different types of data, such as text, graphics, sound, video, and the like. For a typical project, a large number of different types of business content can be created and processed by the system. Each content object may be used by different users and applications within the project. For a complex project involving many users, applications and content objects, strict maintenance of content and process integrity is necessary to ensure that the overall project is performed properly.

In general, a project designer or administrator of a particular cross-team business defines the overall business flow and the people and business content involved in the project. The checkpoint flow usually involves a number of sub-processes and a number of different states. Different people may be involved in different states, this is also generally true for the applications within the project. The business content involved in a cross-team project will typically be managed by multiple user teams or applications, therefore stage and process management is important to maintain the integrity of the content.

FIG. 1C illustrates the processing of business content in an application integration system, according to an embodiment. The example of FIG. 1C shows four teams of users 190, 192, 194, and 196. User 190 operates business application A, 180, which has shared content 181; team 192 operates business application B, 182, which has shared content 183, and user 194 operates business application C, 184, which has shared content 185. User 196 does not run an application, but manages content 186, which may or may not be from a business application used in the project. The content for any of the applications can originate from multiple sources, or it can originate from a single source. Thus, content 181 used by application A could originate from application A or B, while content 185 used by application C could originate only from application C.

FIG. 1C illustrates the collaboration platform and routing process that links the users, applications, and shared business content together. The server 104, web server process 116, data store 120, and application integration process 112 of FIG. 1A are represented as functional hub (or “collaboration hub”) unit 191 of FIG. 1C. Each user, application and/or content data interfaces with the collaboration hub 191 through individual interface links or “registry gates” 193. The content data from each application is stored by the application integration process in one or more data stores, such as storage memory 120 in FIG. 1A. The processing performed on the data includes establishing the links between the applications and users based on the content from each respective application.

Once stored in the collaboration hub platform 191, the content can be considered to be represented by a three-dimensional parameter model. The content for each application contains a regular object description (first dimension), a rich object field matrix (second dimension), and a distributed checkpoint model to manage the content being accessed and controlled by the multiple teams over a time period. The rich object field matrix links the content to the application or applications that use it. Thus, in general, the content is selected and abstracted from the original (silo) application, and stored in the collaboration hub with the three dimensions of descriptive parameters. The data is then leveraged by the program components of application integration process to establish the linkages within the overall project. In general, the collaboration hub stores the information related to the content, process, and users for each application of the project, and the application integration process integrates this information to derive the necessary linkages to create a virtually seamless unified enterprise system from the separate business applications.

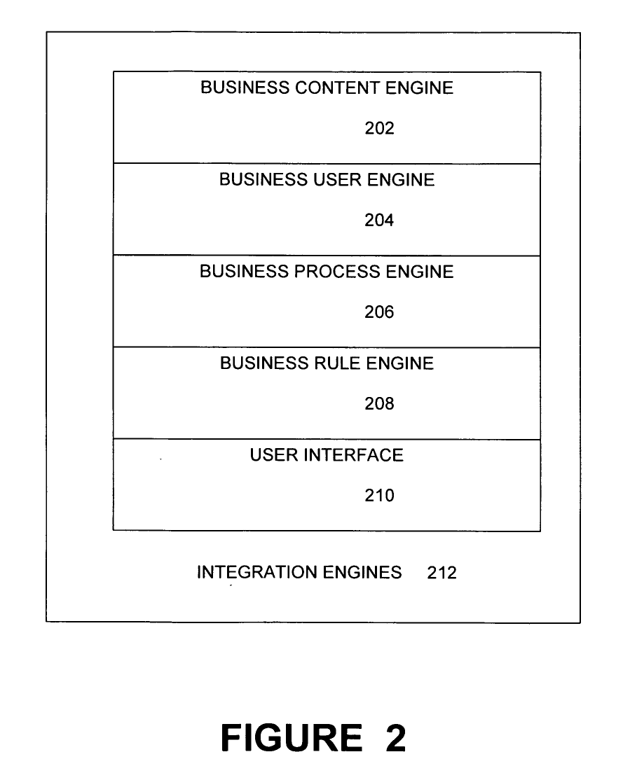

In one embodiment, the application integration process 112 includes a number of different programs (also referred to as “engines”) to define and automate the user's business application, as well as provide a platform execute the application during runtime in a manner that integrates the users, processes, and content of the other applications in the project. FIG. 2 is a block diagram showing the main components of the application integration process, according to an embodiment. The main component programs of the application integration process are provided as integration engines 212 that include: a business content engine 202, a business user engine 204, a business process engine 206, a business rule engine 208, and a user interface engine 210. Various other programs or modules are also provided to facilitate the automation and runtime functions of the application integration process. These include a cache engine, a real time notification engine, a real time change order engine, an integrated reporting engine, and various tools for implementation on a variety of different network platforms. Although some of the programming modules are illustrated in FIG. 2 as comprising individual or separate engines or components, it should be understood that the functionality of these components can be combined into any number of different programming modules within the application integration engine block 212.

Business Content Engine

The business content engine 202 is a programming module that imports, stores and conditions the business content of the user application for runtime execution by the application integration process. It prepares the hooks that provides the content linkage from the different applications, and hands over the rich content data structures to the other engines of the integration engines 212. In general, each separate application, such as 105 and 107 in FIG. 1A operates on content. In the context of the overall project, some of the content is shared among the different applications that are integrated in system 100. The application integration process provides linkages within the shared content to facilitate its access and processing by these applications based on the processing steps of the applications and the characteristics of the users and applications that modify or otherwise manipulate the shared content.

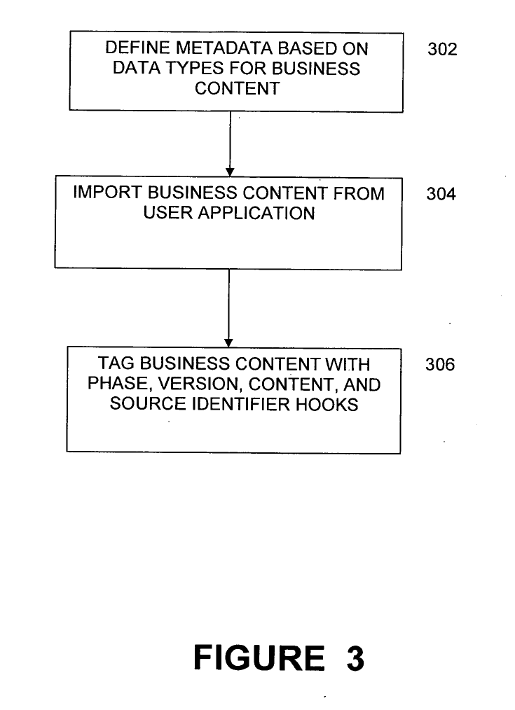

FIG. 3 is a flowchart that illustrates processing steps associated with the business content engine 202, according to an embodiment. In one embodiment, the business content engine describes and stores the collection and combination of data types (metadata) that are used in each business application. Thus, in FIG. 3, the business content engine 202 begins by defining the metadata used by an application program, step 302. In general, the metadata defines the data types used by content objects.

The metadata is created within the business content engine based on definitions provided by the user. In one embodiment, the user can explicitly input, through tools such as the user interface component 210 or through the automatic programming interfaces to import critical content from the applications. The business content engine also includes a parser that can automatically derive the metadata from the raw content imported. The parser is configured to recognize the data type and then automatically define the metadata for the business content. Once the metadata is defined, the business content is imported into the application integration process, step 304. This business content comprises the shared business content that is used by one or more different user teams and/or applications within the overall project. Step 304 may be a substep of 302, or it may be a separate step, as shown. In general, the content creation programs used by the user application store data in a “flat” structure, the data is defined in relation to metadata, and stored in a one-dimensional structure. In one embodiment, the shared content is defined and abstracted from each application. The process then builds the rich object field matrix and provides elements such as application location, user profile and other parameter information. The checkpoint flow then adds an additional dimension based on the application processes.

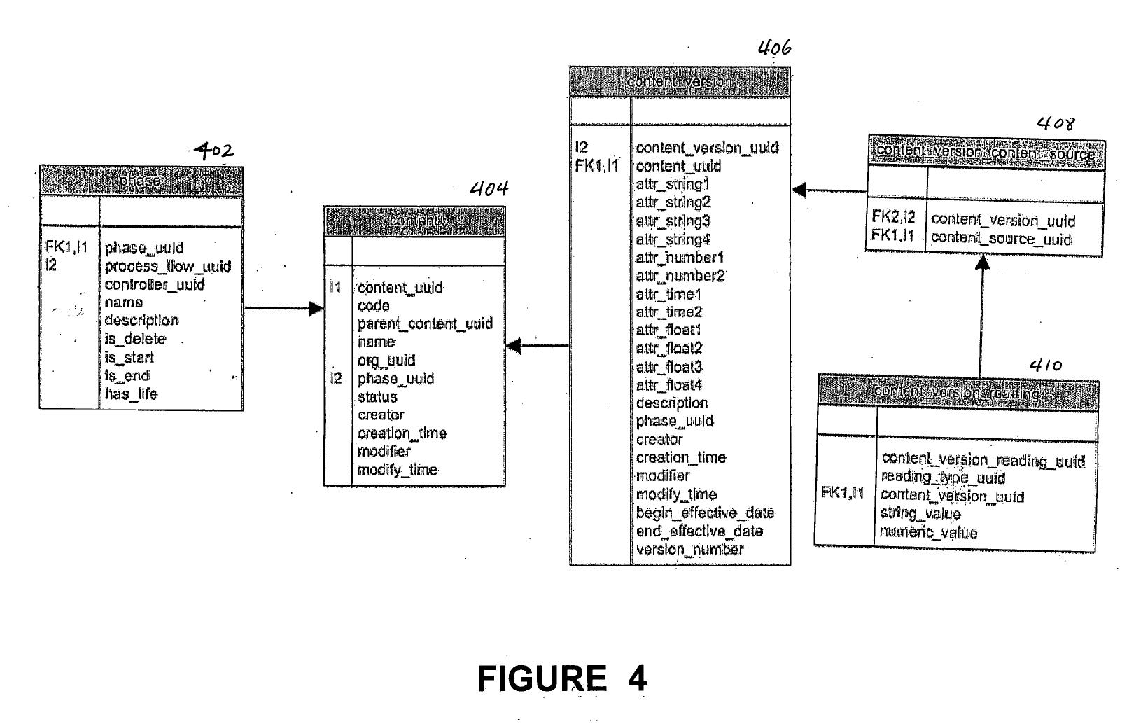

Once the shared business content is defined within the system and/or imported into the application integration process, it is tagged with markers (or “hooks”), step 306. In one embodiment, the hooks include various version and source identifiers that facilitate dynamic process trigger points used by the other processing engines of application integration engines 212 during project definition and runtime execution. FIG. 4 illustrates the tagging of business content with identifier hooks, under an embodiment. Each block of FIG. 4 illustrates a process object corresponding to a function performed by the content engine 202. The left column of each block illustrates an example internal table ID or container ID, while the right column contains the descriptors for the parameters manipulated by that function block. For the diagram illustrated in FIG. 4, the phase block 402 defines the phase or stage (age) of the content itself. As shown in FIG. 4, content can be in a phase corresponding to a start point or an end point, or an in-life point. The phase 402 can also specify the stage of the process or project in which the data is used, and corresponds to the checkpoints that are contained in the workflow of the project. The content is then tagged with various types of identifiers, for example, but not limited to: name, parent or child identifiers, status, creator, creation time, modification history, and so on. In most practical applications, content is modified by applications or users within the application. Thus, the content 404 is also tagged with explicit content version information 406. The version component 406 creates a version number associated with the content and stores critical version information such as modification time, modification source, and duration (start/end time) for the version. The content version object 406 itself is conditioned by a content source 408 object, which describes the sources of the content, and a content version reading component 410, which provides the access filters.

Different applications can impact the same set or type of data constituting the shared content, even though this content may be treated differently by each application. For example, with reference to FIG. 1C, application A, 180 and application B, 182 may both use the same business content (e.g., a customer list) within the system. These applications may be the same or they may be different, in which case the customer list information stored on the hub may be an integrated or composite data object that is managed by the two different applications. Thus, the content objects stored on the hub 191 may come from two or more different sources. To maintain the integrity of the shared content, the applications must synchronize their activities with regard to the shared content.

Business User Engine

With reference to FIG. 2, the business user engine 204 is a programming module that defines and stores the identity, hierarchy, and privileges of the various users of the content data defined and stored by the business content engine 202. The users processed by the business user engine may be any person, entity, application program, or software module that creates, modifies, views, or otherwise impacts the business content within the system. In most practical applications, any number of users may be allowed to access and/or modify the business content. The business user engine enforces the hierarchical and privilege rules associated with or assigned to the users of the system. Typically each user who accesses or “touches” the content through the course of the project is assigned a privilege or a role. This role will govern the privileges with regard to who can create, view, modify or destroy any shared content object. The role assigned to each user is also utilized in the checkpoint flow defined for the application. The checkpoint flow defines which users or applications are required to touch a particular content object at a given period of the project checkpoint flow. The role/privileges of a user or application may be different with respect to the same content over time, depending on the content stage in the checkpoint flow.

Users and/or applications may be associated with different business content created and defined by the system. Each element of business content defined for the multiple applications and the users of that content comprise a “hub” (such as the collaboration hub 191 illustrated in FIG. 1C). A distributed collaborative environment may comprise a number of different hubs, each with its own business content and group of user and applications, as well as project scope. A user or application within the system may be associated with two or more hubs. That user's privilege may be the same or different for both hubs. In one embodiment, the collaboration platform element 122 of the application integration process manages the creation and maintenance of the collaborative hub formed around server 104 in system 100.

Business Process Engine

The business process engine 206 controls the series of critical checkpoints of business content within the application integration process 112. The application integration aspect of this process uses the concept of “checkpoints” to mark significant milestones or transition points during the checkpoint flow of the business content. The business process engine 206 is a content sensitive module that provides dynamic checkpoint control over any item or unit of business content. As business content is processed by the system, it undergoes modification or validation through the use of checkpoints defined by the business process engine. This engine defines and maintains one or more checkpoints at which the business content undergoes a transition or modification. The transition or modification can be effected by one or more users of the system and/or one or more applications of the system. The transition or modification at each checkpoint can be an act that modifies the business content in some way, validates the content, routes the content within the system, or any other processing step or combination of processing steps that impacts the business content.

In one embodiment, each checkpoint includes a gate or phase control point, a user hook, a content hook, and a transit locking mechanism. The business process engine is configured to learn or define the checkpoints of the business content, and create the metadata space for the business content phase hook for each of the checkpoints. The checkpoints can also include any business rule that triggers the automation of the business processes. In general, a business rule is a rule that modifies, validates, routes or otherwise processes the business content depending upon one or more variables or conditions. Rules are translated into event rules and locking rules and passed on to both an event engine and locking engine within the application integration process. These rules are also converted into passive read-only and interactive read/write action event components for involved silo applications, and interactive read/write graphical components for display to the end users.

The checkpoint flow of the process essentially comprises the timeline of the application and comprises transition points that result in content change by a user and/or application. The checkpoint flow of a content object can include one or more sub-checkpoint or even sub-bus-checkpoint flows recursively. Each sub checkpoint node (leaf node) can consist of interactive processes and business rules.

FIG. 5 illustrates the concept of transitioning a business content unit through checkpoints, according to an embodiment. As illustrated in FIG. 5, a unit of business content 602 is created and modified over a timeline 610 that represents the checkpoint flow of the content object from creation through modification and eventually to termination. The current state of the content object is represented by slider window 608. The business process engine 604 defines and maintains one or more checkpoints 606. At each checkpoint 606, the content object undergoes a transition or modification. The transition or modification can be effected by one or more users of the system and/or one or more processes of the system. The transition or modification at each checkpoint can be an act that modifies the business content in some way, validates the content, routes the content object within the system or organization, or any other processing step or combination of processing steps that impacts the business content.

In one embodiment, each checkpoint 606 includes a gate or phase control point, a user hook, a content hook, and a transit locking mechanism. The business process engine 604 is configured to learn or define the checkpoints 606 of the business content 602, and create the metadata space for the business content phase hook for each of the checkpoints. The checkpoints can also include any business rules that may be defined by a group of users. In general, a business rule is a rule that modifies, validates, routes or otherwise processes the business content depending upon one or more variables or conditions. The business process engine 604 learns the business rules, which define which user can do what act and when, and generates the dynamic and interactive graphical user components of the business content and business process for users and the action events for applications to access and modify the business content. Rules are translated into event rules and locking rules and passed on to both an event engine and locking engine within the application integration engines 212. As the business content traverses over a checkpoint (represented in FIG. 5 by sliding window 608 sliding under a checkpoint 606), the business process engine 604 creates a metadata space for the business content “version” hook to track each iteration of the business content. As the sliding window 608 traverses through the checkpoint flow 610 and past the checkpoints 606, a “snapshot” representing the state of the business content at that particular time is stored. Any number of checkpoints can be defined, depending upon the requirements and constraints of the application. All versioned business content is linked together based on the check point hit. An interactive graphical component is generated for any group of users and the interactive action event is generated for applications to jump to the desired cycle of the business content.

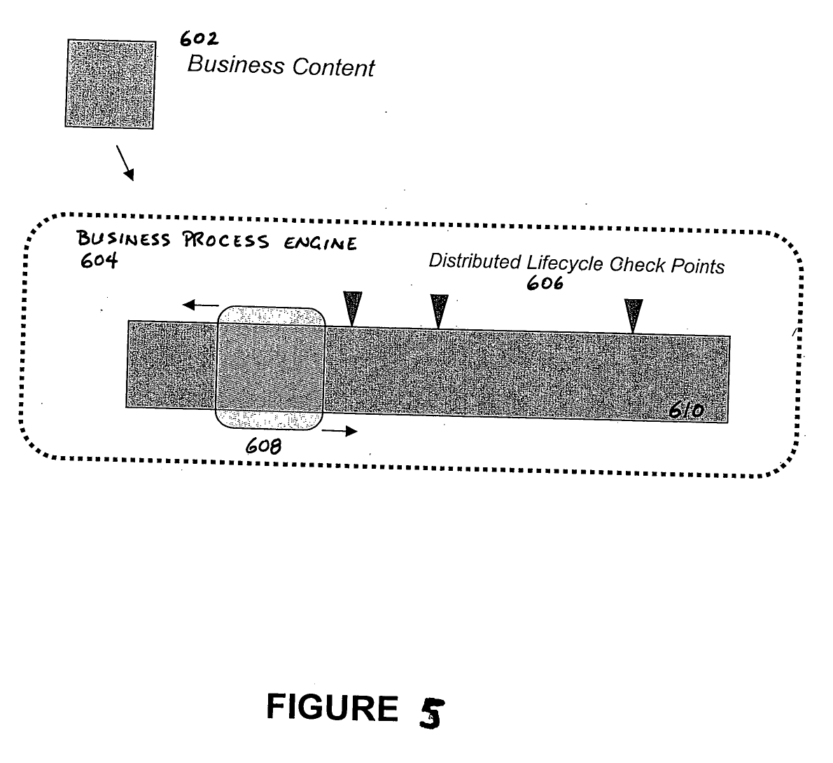

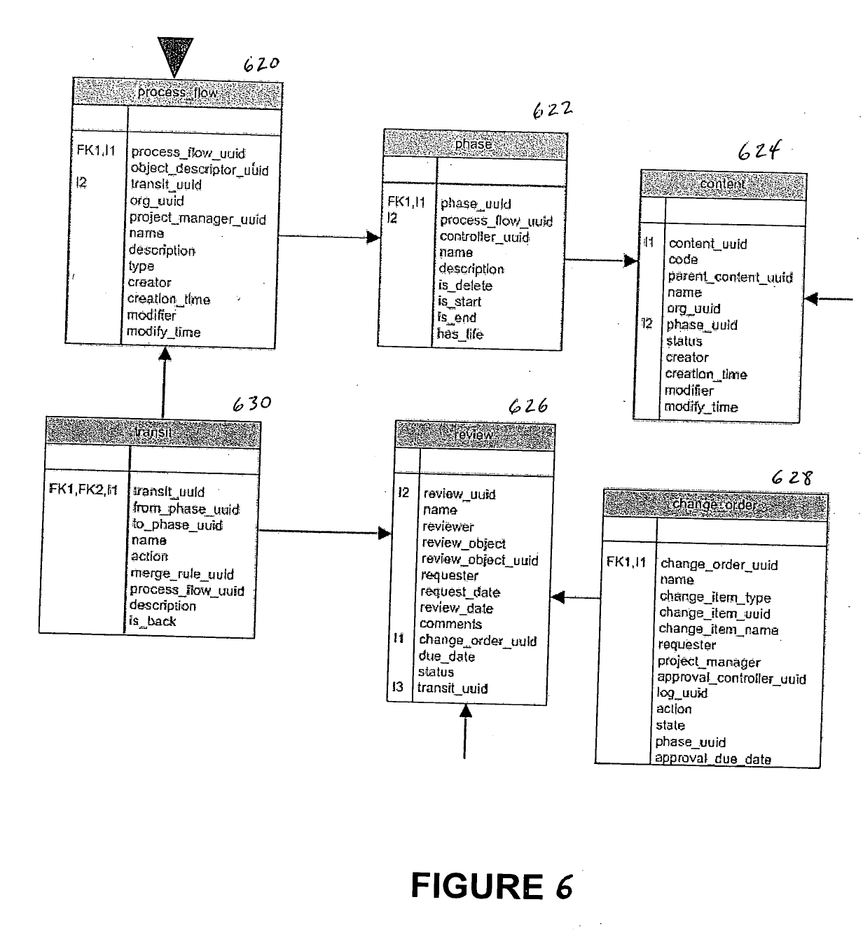

FIG. 6 illustrates the association of process flow with phase and business content, according to an embodiment. Each block of FIG. 6 illustrates a process object corresponding to a function performed by the business process engine 206. The left column of each block illustrates an example internal table ID or container ID, while the right column contains the descriptors for the parameters manipulated by that function block. The process flow object 620 includes a number of parameters including identifiers for the project manager and business content—name description, type, creator, and so on. The phase object 622 defines the phase of the business content object, such as active (has life), started, ended, deleted, and so on. The phase and process flow objects help define the content object 624. The approval chain activity defined for the process flow are driven by the review 626 and change order 628 objects. These objects are controlled by a transit object 630, which also modifies the process flow 620. The transit block 630 marks the transit between the checkpoints and the correspondent locking rules are invoked during the transit period.

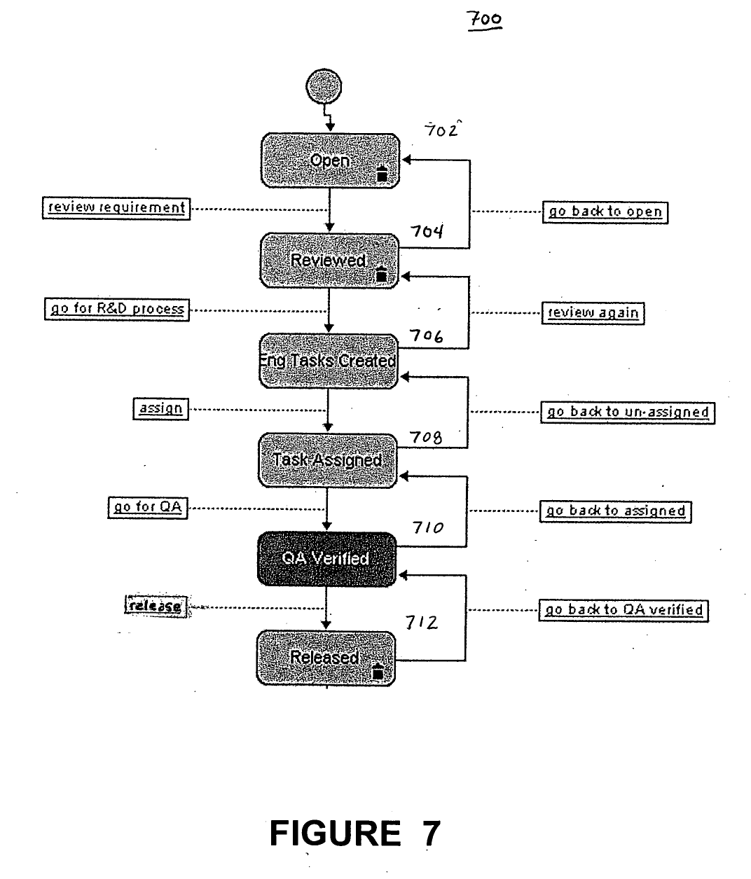

In one embodiment, the process represented by checkpoint flow 610 in FIG. 5 and object 620 in FIG. 6 corresponds to the main checkpoint flow of the entire business project as it is implemented by the application integration process 112. FIG. 7 illustrates an example of the checkpoint flows for an illustrative content object, under an embodiment. In FIG. 7, a particular application comprises a number of steps associated with the execution of tasks and the creation, modification, or access of the business content. The workflow process 700 starts with the open step 702 that opens the project and defines the business content objects. The business content is reviewed in step 704, and then the steps of task creation 706, task assignment 708, and quality assurance verification 710 are performed before the content is released in step 712. The entire process 700 of FIG. 7 represents the checkpoint flow for the project, and each discrete step in process 700 represents a checkpoint. Each checkpoint may have one or more sub-checkpoints associated with it, each with its own set of sub-subcheckpoints. At any checkpoint, an approval chain may be attached. As the project progresses through the steps, the business content will be created and modified and passed on to successive steps by the various approval chains or other interactive processes (such as notifications and actions) defined for the project. As shown in FIG. 7, there may be several feedback loops in which the business content is sent back to previous process steps for further action and approval.

Each checkpoint of the process may trigger an interactive process, such as an approval requirement of the business content by a user. The approval chain defines the hierarchies of the users and validates the approval of the business content to allow the process to progress to a successive checkpoint. Other types of interactive processes, such as notifications, actions, alarms, exception processes, and so on will implicate other applications and/or users, or the business rules of the process.

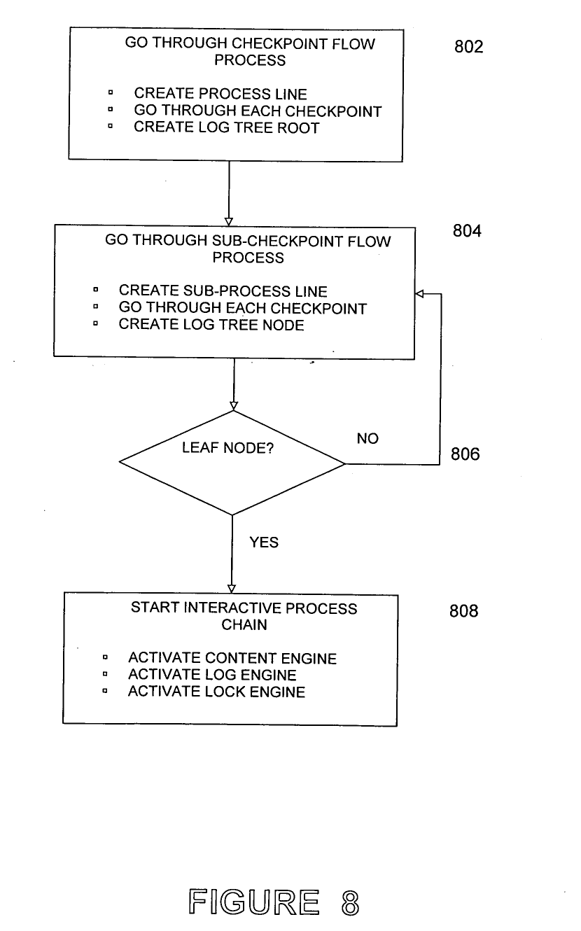

FIG. 8 is a flowchart that illustrates the process flow through the checkpoint flow process, according to an embodiment. The main steps of FIG. 8 illustrate that the process first goes through the checkpoint flow for the application, 802, then any sub-checkpoint flows for the application, 804. At step 806, the process checks whether the sub-checkpoint flow is a leaf node. If not, the process recursively goes to the next sub-checkpoint flow. If it is a leaf node, the process then starts the interactive processes for any of the checkpoints or sub-checkpoints of the leaf node, 808. The checkpoint flow may include one or more sub-checkpoint flows, each of which may include one or more sub-subcheckpoints, and so on to form the recursive structure illustrated in FIG. 8. The interactive process of block 808 is any type of interactive process that occurs or is executed at a checkpoint or sub-checkpoint, as long as it is a leaf node checkpoint. An approval chain, for example, is one type of interactive process that may be executed at a sub-checkpoint. Other such processes include conditional rules, actions, notifications, and so on

In one embodiment, when the checkpoint flow for a content object is started, as shown in step 802, the following programs of the application integration process are triggered. First, an instance of the collaboration process is generated. This is a process line which is represented as a linked list of the check points. A collaboration project is created as well which will be used to track the users and applications involved in the checkpoint flow of the content. As the process transitions from one phase of the project to a successive phase as designed in process engine, various processes are triggered. At the start point of each transition, a check point will be automatically added into the process line, the lock engine will lock the content object in the transition period if any sub-checkpoint or interactive process is defined, and a main node of the collaboration log will be created and attached to the project created at the process starting point and also to the content object.

At the end of the transition, the lock engine unlocks the content object and releases it to other users or applications. A new version of the content object is generated and marked with the phase. The main node will then be marked with the new version of the content object. As stated above, depending upon the application and its implementation, the main checkpoint flow can have one or more sub-checkpoints. Each sub-checkpoint flow can plug recursively into a checkpoint of the process, and interactive process chains can be plugged into any leaf node checkpoint. When the content reaches the end of the checkpoint flow, the project created will be marked as closed.

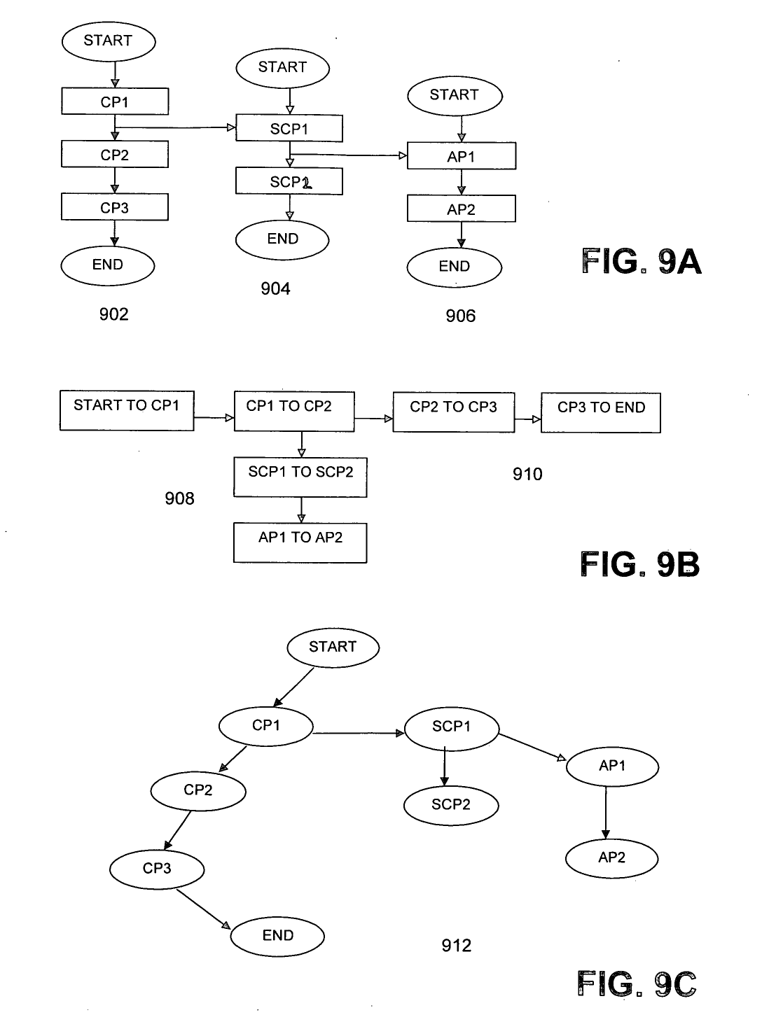

In general, the checkpoint flow of a project is defined as a series of transitions between checkpoints, sub-checkpoints and interactive processes. FIG. 9A illustrates the definition of checkpoints and interactive processes for an example process, under an embodiment. As illustrated in FIG. 9A, main checkpoint flow 902 consists of a process that has a start point and transitions through three checkpoints CP1, CP2, and CP3, before ending. At the transition between CP1 and CP2, the process transitions to a sub-checkpoint sequence 904 consisting of sub-checkpoints SCP1 and SCP2. Although FIG. 9 illustrates a two-layer example, it should be noted that the process can have any number (N) layers.

For the example shown in FIG. 9A, the transition between SCP1 and SCP2 involves an interactive process chain 906 consisting of two application process steps AP1 and AP2. FIG. 9A illustrates the breakdown of an example checkpoint flow, such as that illustrated in FIG. 7, into a series of checkpoint transitions, sub-checkpoint transitions, and interactive process transitions. From this checkpoint flow based representation of the integrated business flow, various other representations of the application process can be derived.

FIG. 9B illustrates the derivation of a transition node tree for the checkpoint flow and interactive process flow of FIG. 9A. A transition node tree represents the transitions among the checkpoints and interactive processes of the process. Each block within the diagram of FIG. 9B represents a transition between action steps, as opposed to an actual action step (e.g., checkpoint or interactive process step). As illustrated in FIG. 9B, the transition node tree corresponding to the flow of FIG. 9A consists of the transitions from start to end through the main checkpoints CP1 to CP3, as shown on axis 910. For the transition from CP1 to CP2, the program flow branches to the sub-checkpoints 1 and 2 (SCP1 to SCP2). This transition branches to the interactive process chain containing application process steps AP1 and AP2.

The process flow can also be represented as a tree structure consisting of the checkpoint and approval steps as nodes. FIG. 9C illustrates the derivation of a node tree for the checkpoints and interactive processes (approval chains) of FIG. 9A. The tree structure 912 illustrated in FIG. 9C provides a slightly simpler representation of the flow diagram of FIG. 9A, and the node transition diagram of FIG. 9B.

The collaboration hub defined by the application integration process that ties together the different teams can manage multi-layer approvals and process control. The checkpoints can thus be distributed to different teams, as can the derived interactive process chains. This creates a true collaborative platform for on-demand application integration.

In an embodiment of the application integration process, there are four objects involved in the business process engine, which are as follows: the process definition, the process instance, the content instance, and the collaboration log instance. The process definition is a checkpoint flow process represented as a tree structure of flows. The process instance is a tree structure representation of the process spread from the process definition. The tree structure levels are the mirror of the process definition. The number of state node instances in each level is programmatically defined by the real time movement of the process. The content instance is a flat list of versions of each content object. Each version is stamped with one of the process node identifiers. It is presented as a mirror of the tree structure of process instance, but trimmed off the interactive process chain nodes. The collaboration log instance starts with project, and is the mirror of the tree structure of the process instance. The collaboration log instance logs all of the activities along the process instance from both the checkpoint flow and the derived interactive process chain and approval chain processes.

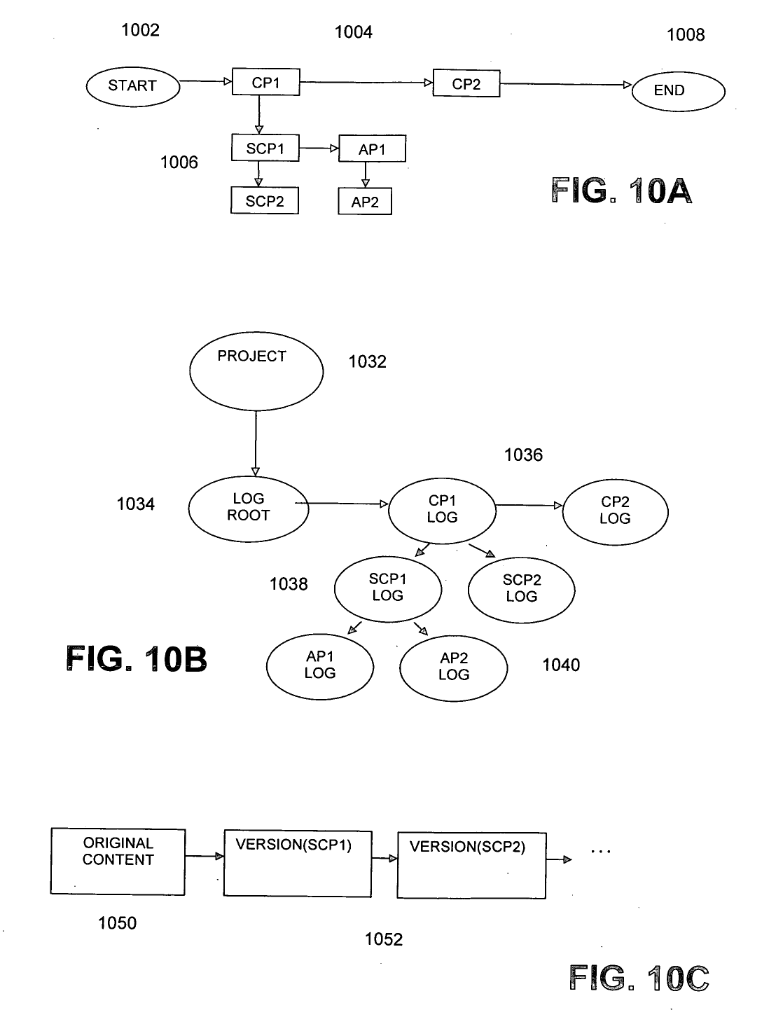

FIG. 10A illustrates an example of a process instance representation of a process definition, under an embodiment. The process instance of FIG. 10A corresponds to the process flow illustrated in FIG. 9A. The process starts at point 1002 and ends at point 1008. In between, the process contains two checkpoints 1004 denoted CP1 and CP2. For the example of FIG. 10A, checkpoint CP1 contains two sub-checkpoints 1006 denoted SCP1 and SCP2, with SCP 1 having application process steps AP1 and AP2. Again, the application process chains AP1 and AP2 illustrate possible interactive process, such as conditional rules, sets of actions, or set of event notifications.

As stated above, a collaboration log instance is created for each process instance. FIG. 10B illustrates an example of a collaboration log for the process instance illustrated in FIG. 10A. Upon definition of the project 1032, a log root 1034 is created. For the process instance of FIG. 10B, there are log instances 1036 for CP1 and CP2. From the log instance for CP1, there are two sub-log instances 1038 for the two sub-checkpoints SCP1 and SCP2. For the interactive process chain instances within SCP1, there are corresponding log instances 1040 for application processes AP1 and AP2.

As the process transitions from the checkpoint and sub-checkpoint transitions, the content may be modified. As stated above, the content instance is a flat list of versions of each content object. FIG. 10C illustrates an example of a content instance for the process instance illustrated in FIG. 10B. Each version of the content as the process proceeds through the transitions is captured along a linear timeline. A version control engine within the business processing engine defines and manages the content version at each stage (checkpoint/sub-checkpoint) of the overall project cycle. The original content instance 1050 is versioned at each transition 1052 represented by a checkpoint or a sub-checkpoint. Thus, for the example of the process instance of FIG. 10B, the first transition is sub-checkpoint 1 (SCP1) of checkpoint 1 (CP1). The content at this transition point, sub-checkpoint 1, is marked as Version(SCP1), V_{SCP1}. Likewise, the content at the second transition point, which is sub-checkpoint 2 SCP2, is marked as Version(SCP2), V_{SCP2}. The interactive process, here the application process chain (AP), instance is not captured by the content instance. A version control engine within the business process engine controls the versioning of the content at each checkpoint. The log engine associates particular versions of the data with the processes logged by the system. In one embodiment, all versions of any modified data are stored in a data store. Alternatively, the only the most current data is stored along with modification histories stored by the log and version control engines. This allows recreation of earlier versions of the data by recreating earlier modification steps to the current data. The version control engine and storage of historic content allows the system to automatically recreate earlier versions of data when the process is backtracked through earlier transition points, as shown in 6A. Thus, as shown in the business process engine block 604, if the sliding window 608 is moved leftward (toward the past), earlier versions of the content data can be called up and viewed through the graphical user interface component of the application integration process.

It should be noted that the processes and various representation of the processes, logs, and content illustrated in all of FIGS. 9 and 10 are for a particular example in which the process flow includes two checkpoints, two sub-checkpoints, and two interactive processes. Many other process flows are possible, depending upon the actual project scope of the applications being automated and integrated.

Additional Engines

In one embodiment, the application integration engine block 212 includes other processing components or engines to facilitate the automation and/or runtime integration of the business users and applications. A locking engine locks the content either at a checkpoint or in between checkpoints so that its integrity can be maintained. Different levels of locking can be defined. In one embodiment, the locking engine may be configured to overrule the access privileges defined for the users and applications. The locking engine can also be configured to control whether the process continues along the defined workflow. In this manner, a process may be halted at a particular checkpoint or sub-checkpoint regardless of whether business rules allows the process to continue. This facilitates the integration of fault recovery and alarm conditions with the entire project cycle.

In one embodiment, a business rule engine is incorporated within the application integration engines 212. Business rules may be applied to any or all checkpoints and sub-checkpoints within the checkpoint flow of a process. A business rule typically comprises a set of conditions. If the conditions are met, processing rules are invoked that may perform the combination of actions such as modifying the content, routing the process, sending an alert, terminating, or invoking an involved application process. The business rule engine monitors the condition of the checkpoint flow and causes execution of the business rule at a particular checkpoint if the condition is met during transition of the workflow through that checkpoint.

Interactive Console Engine

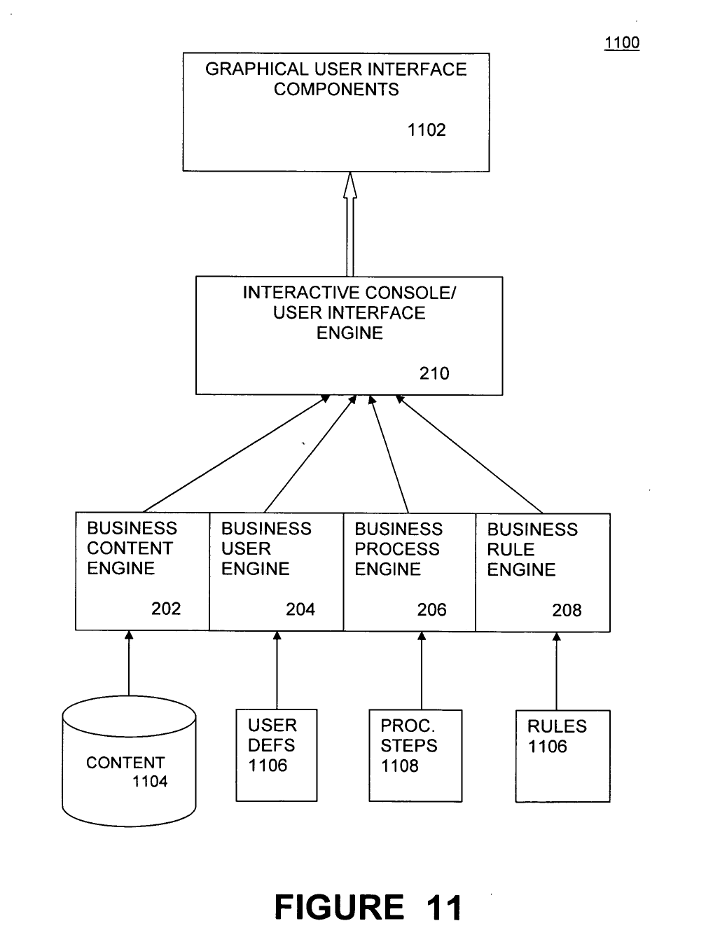

In one embodiment, the application integration process uses a graphical user interface for end users to collaborate with each other for the shared business content within a joint project. The integration engine block 212 includes an interactive console engine, also referred to as a user interface engine (such as user interface engine 210 of FIG. 2) that provides a comprehensive interface between the users and the business content throughout the entire project cycle. FIG. 11 illustrates the generation of user interface components by an interactive console/user interface engine, under an embodiment. The interactive console engine 210 constitutes a middleware layer that generates the on-screen graphical user interface (GUI) elements on the user's computing devices on demand. As illustrated in FIG. 11, the interactive console engine 210 receives input from the other major engines, including the business content engine 202, the business user engine 204, the business process engine 206, and the business rule engine 208. These engines provide the data, objects, and processes that the interactive console engine uses to generate the displayed the interactive GUI components 1102. Thus, business content 1104 is provided by the business content engine 202, user definitions 1106 are provided by the business user engine 204, the process steps 1108 for each application are provided by the business process engine 206, and the business rules 1106 are provided by the business rule engine 208.

In general, the GUI components shown on the users' screens are not hard-coded objects, but are dynamic variable components that are defined depending upon the shared business content and application processes. The interactive console engine 210 automatically generates the GUI components at runtime execution of the applications. This enables the components to change dynamically depending upon the checkpoints of the process flow and the content being accessed.

The interactive console engine 210 also implements the interactive locking mechanism. The GUI components representing data objects or actions to be taken on data are automatically hidden or rendered unusable when the particular data or action is in a transition period, and then released automatically when there is no queuing of pending transaction requests.

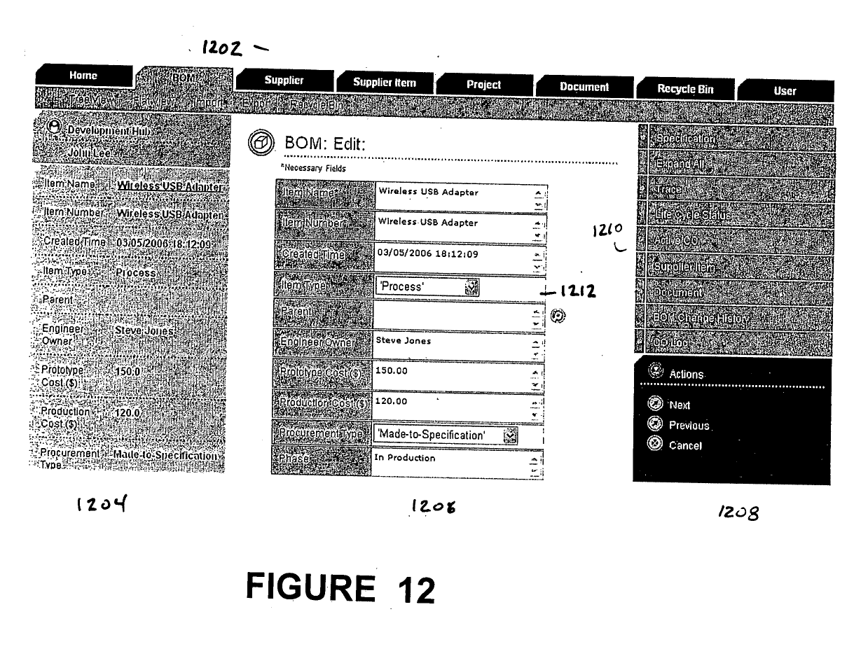

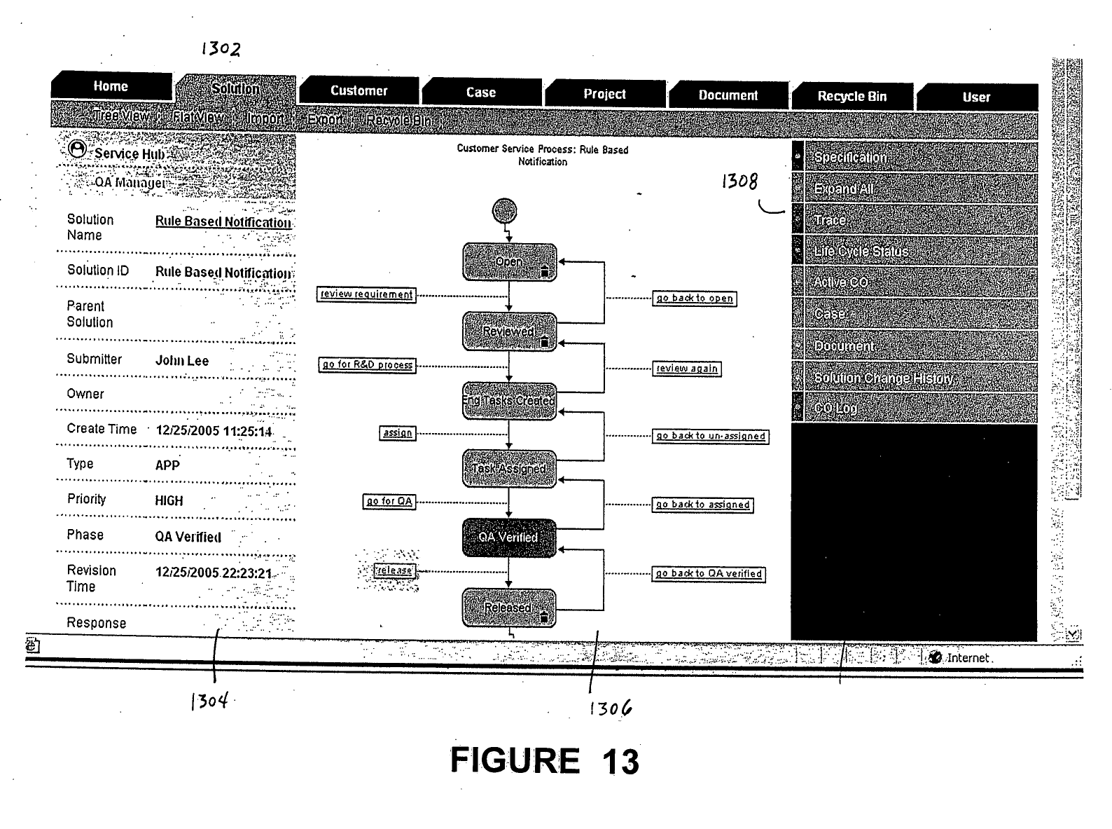

As described above, the application integration process uses a graphical user interface for cross-team project interactivity. The main user interface screen, as illustrated in FIGS. 12 and 13, contains a menu bar that allows the user to access the various tools, screens, and resources associated with the business content runtime. The user can bring up various aspects of the content by selecting the appropriate menu button.

In one embodiment, a number (e.g., three) of display panels allow viewing and interaction with various aspects of the cross-team project. One of the display panels, such as center display panel 1206 can be considered the main display panel that illustrates the associated activities of the shared content being accessed or the content object for the shared data. In FIG. 12, display panel 1206 displays the shared business content, and display panel 1208 illustrates the content associated detail categories. Display panel 1204 displays a summary of the selected categories, so once a category is selected, its details will be displayed in panel 1206.

As different groups of users interact with each other on the same business project, they may interfere with one another with respect to the shared content. Using the GUI components, multiple users can work on the same shared content in a harmonious manner through the synchronization provided by the checkpoint flow process, role based access control and time-based/checkpoint-based locking mechanisms. For example, a Bill of Materials (BOM) document for the manufacturing process is displayed in display panel 1206. By selecting one of the category details from panel 1208, e.g., the “lifecycle status,” the current BOM checkpoint flow status will be displayed in panel 1106.

As shown in FIG. 13, a particular application can comprise a number of steps associated with the execution of tasks and the creation, modification, or access of the business content. The checkpoint flow displayed in panel 1306 represents the life cycle of the BOM shown in FIG. 12. The BOM business content is reviewed and then the steps of task creation, task assignment, and quality assurance verification are performed before the BOMs are released. Each checkpoint may have one or more sub-checkpoints associated with it, each with its own set of sub-checkpoints. Processes, rules or actions (such as approval chains) may be attached to a sub-checkpoint. As the project progresses through the steps, the business content will be created and modified and passed on to successive steps by the various sub-checkpoint processes defined for the project by the various teams involved.

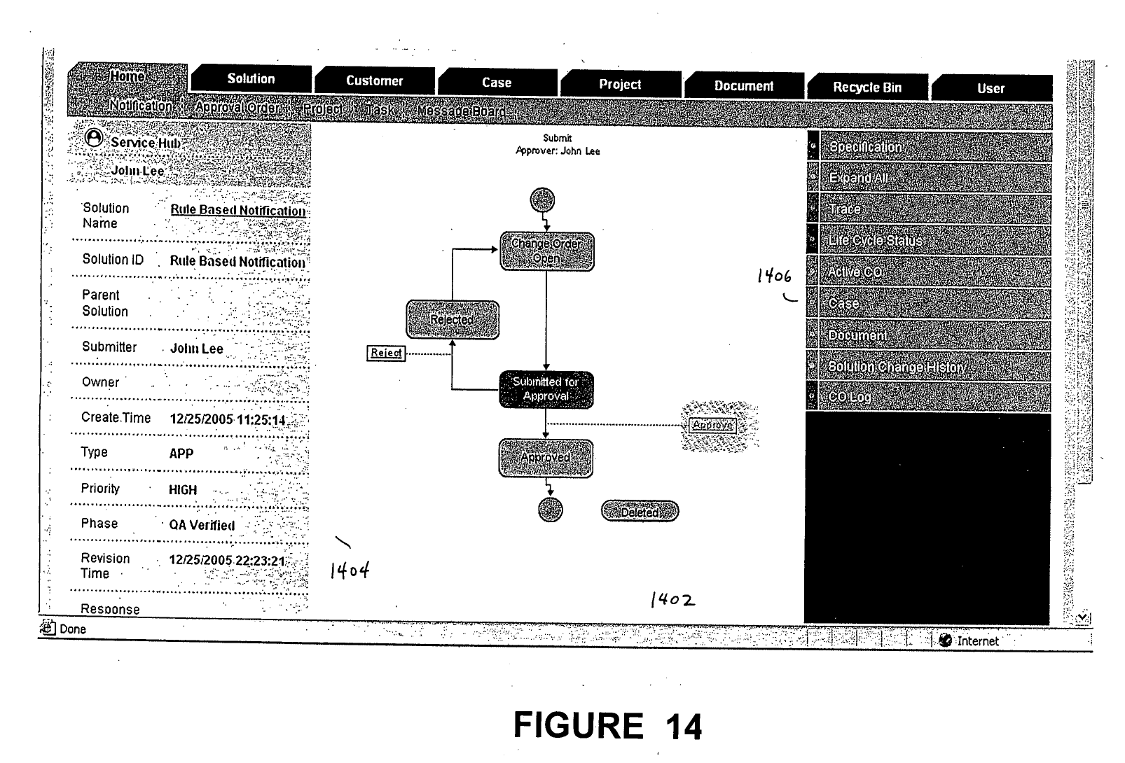

As stated above, the sub-checkpoints can be interactive processes such as conditional rules, application processes, events, and so on. FIG. 14 illustrates an example of an approval subprocess for the checkpoint flow process illustrated in FIG. 13. As shown in FIG. 14, the main display panel 1402 illustrates the steps that comprise the approval process for a particular sub-checkpoint flow. Panel 1402 can be displayed recursively to reflect the layers of the checkpoint flow. Information regarding the current shared content related to these steps is provided in display panel 1404, and display panel 1406 provides access to other content associated categories.

The user interface screen shots provided in FIGS. 12 through 14 are intended to provide an example of the possible layout of content according to embodiments. It should be noted that the actual components, the type of data or processes displayed, and the organization of the GUI components can vary depending upon the requirements and constraints of the overall project. The user interface can be embodied within web pages served by the web server process 116 and viewed through respective web browser processes 112 on the client computers. Alternatively, the user interface can be embodied within the display parameters defined by the computers and networks comprising the project environment.

In one embodiment, the application integration process may be provided as a service that can be used by all involved cross teams without the need for the user to install or maintain any software and hardware on the user's computer or network. The application integration process is scalable so that the user can define any scope of the business project desired, from a single project to an entire integration system involving many distributed applications integration and data synchronizations.

Embodiments of the application integration system described herein may be applied to various types of computer applications, software applications, communications software such as mail, message or content delivery methods utilizing communication over the Internet or similar distributed network.

Aspects of the application integration system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the application integration method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the application integration system is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the application integration system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims. While certain aspects of the application integration system are presented below in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method of integrating a plurality of users and applications to form an integrated enterprise project comprising:
defining process steps associated with each application of the plurality of applications;
defining shared content used by each application;
identifying a user from the plurality of users for each business application;
deriving an overall process flow for the integrated enterprise project based on the process steps associated with each application, the overall process flow including one or more checkpoints defining a version of the shared content; and
displaying on a workstation computer coupled to the server computer, and operated by the user, selectable components providing access to the shared content, wherein the components are automatically defined by the server process based on the shared content and a current checkpoint status of the overall process flow.

2. The method of claim 1 further comprising the steps of:
deriving metadata from the shared content used by each application; and
defining role based access control privileges associated with each user of the plurality of users of the shared content, wherein the user has associated access privileges based on the user's role within the overall enterprise project.

3. The method of claim 2, wherein one or more of the selectable components is locked from access by the user based on at least one of the associated access privileges of the user and a phase of the process flow at a checkpoint of the one or more checkpoints.

4. The method of claim 1, further comprising the steps of:
tracking the version of the shared content; and
storing historical data associated with the business content including a state of the business content at a version earlier than a present version.

5. The method of claim 4, wherein a selectable component of the selectable components causes the display of the earlier version of the shared content.

6. The method of claim 1, further comprising:
providing a first display area configured to display a content object of the shared content; and
providing a second display area configured to display parameters associated with the content object.

7. The method of claim 6, further comprising:
providing a third display area configured to display action items capable of being performed on the content object; and
providing a fourth display area configured to provide communication access to one or more other users of the business project.

8. The method of claim 6 wherein the first display area is further configured to display a checkpoint flow process displaying selectable checkpoints that represent transition nodes of the content object.

9. The method of claim 8 wherein the first display area is yet further configured to display a sub-checkpoint that is executed within the transition node of a checkpoint of the checkpoint flow process.

10. The method of claim 9 wherein the workflow sub-checkpoint comprises one of a notification, an alarm condition, a business rule, and an approval process for the content object.

11. The method of claim 10 wherein the content object comprises one of a document, a database, a spreadsheet, a graphics file, a sound file, and a video file.

12. A system comprising:
means for receiving business content information from a business content component storing shared content used in an enterprise project consisting of two or more integrated application programs;
means for receiving process flow information for an application program of the two or more integrated application programs from a business process component, the process flow modifying the shared content used in the enterprise project;
means for receiving user information from a business user component storing profile information for one or more users of the application program; and
means for configuring displayed graphical user interface components including command buttons on a display screen of a workstation operated by the one or more users.

13. The system of claim 12 further comprising means for receiving business rule information from a business rule component, and wherein the graphical user interface components are further configured based on the business rule information.

14. The system of claim 13 wherein the configuration of the user interface components comprises at least one of type of command and accessibility of the command by the user.

15. The system of claim 14 wherein the configuration of the user interface component comprises accessibility to other business content objects of the application program.

16. The system of claim 15, wherein the accessibility is defined by role based access control privileges defined for the user.

17. A collaborative network system including a plurality of networked computers each executing a separate application program, the system comprising:
means for defining a checkpoint flow process for an enterprise project implemented by the system, the checkpoint flow process modifying content used in the enterprise application, wherein the checkpoint flow includes one or more transition nodes each causing modification of shared content used by separate applications;
means for storing the shared content on a first computer of the plurality of networked computers; and
means for providing access points to the shared content to additional computers of the plurality of networked computers, the access points including profile filters defining one or more parameters related to a users of the additional computers and respective applications programs executed on the additional computers.

18. The system of claim 17, further comprising:
means for defining the shared content in terms of content object types comprising the shared content; and
means for tagging the shared content with version information representing instances of the shared content based upon processing of the content at each checkpoint.

19. The system of claim 18, further comprising:
means for defining role based access control privileges associated with each user of a plurality of users of the content; and
means for tagging the shared content with access filters that limit access to the shared content based on the role based access control privilege of each user, the access filters processed by the access points to allow or deny access to the shared content.

20. The system of claim 19, further comprising:
means for tagging the shared content with identifier information including source information identifying a source application program and user information identifying a modifying user; and
means for incorporating version history information into the shared content, the version history information including at least one of creation time, modification time, and modification source.
